(19) United States
(12) Patent Application Publication
(10) Pub. No.: US 2005/0245678 A1
(43) Pub. Date: Nov. 3, 2005

(54) Polymeric stabilization composition and method

(75) Inventor: Lloyd W. Marsden, Sheridan, WY (US)

Correspondence Address: MERCHANT & GOULD PC, P.O. BOX 2903, MINNEAPOLIS, MN, 55402-0903, US

(73) Assignee: Rantec Corporation, Ranchester, WY (US)

(21) Appl. No.: 11/144,531

(22) Filed: Jun. 2, 2005

Related U.S. Application Data
(63) Continuation of application No. 10/826,122, filed on Apr. 15, 2004.
(60) Provisional application No. 60/463,832, filed on Apr. 16, 2003.

(51) Int. Cl. C08K 3/00

(52) U.S. Cl. 524/612

(57) ABSTRACT

Embodiments of the present invention are methods and chemical compositions of polymers and crosslinking agents that are particularly suited to aggregate, including soil and other natural aggregates, stabilization via hydraulic application. The present invention is an improvement over existing methods as it provides effective stabilization for longer periods. The compositions, when in an aqueous solution and applied to soil or aggregate surfaces, penetrate the surface polymerize and form a crosslinked polymer film. Individual aggregate particles may bind to the polymer or may be entrapped by the polymer film. In the environment, the film is substantially resistant, in the near term, to biodegradation and natural, physical degradation due to weathering and exposure. The resultant polymer film and aggregate or bonded fiber matrix resists erosion by strong wind and heavy rain but readily allows seeds to germinate and grow. The crosslinked film is also substantially insoluble but nevertheless is biodegradable over the long term, ultimately decaying into harmless products. In addition a procedure for control of viscosity in the field application is described making possible cost savings by reducing the amount of required water for delivery.

### RELATED APPLICATIONS

This application claims the benefit of U.S. Provisional Application 60/463,832, entitled POLYMERIC STABILIZATION COMPOSITION AND METHOD, filed Apr. 16, 2003.

### FIELD OF THE INVENTION

This application relates generally to polymer stabilization and more particularly to a stabilizing binding composition.

### BACKGROUND OF THE INVENTION

Often it is desirable to stabilize aggregates, such as bare soil, in the environment to prevent erosion or release of aggregates to the air or water. For example, it is now necessary under some environmental air quality laws, such as the Environmental Protection Agency's (EPA's) PM₁₀ regulations, to control the airborne dust emissions from a construction site. Such air quality requirements also pertain to any source of airborne dust, such as dust emission from coal piles, mining overburden piles and dry tailings impoundments. Prevention of erosion is also important in many construction projects, as is control of detrimental impacts on offsite water quality resulting from aggregate-contaminated surface runoff covered under discharge permits and storm water runoff legislation. An additional stabilization application is the control of erosion following wildfire damage, which is essential for protection of watershed, reservoirs, and prevention of catastrophic soil failure.

Control measures for stabilizing aggregate surfaces to prevent dust include the surface application of water to dampen the surface. Additives to the water may be included such as oils (often used on road surfaces to prevent dust from vehicle operations) and salts. Such dust control measures are short term solutions, expensive, and do little if anything to prevent erosion due to rain or snow. In addition, these control measures may adversely impact surface runoff.

Control measures for stabilizing aggregates against surface runoff include the placement of netting and physical barriers, such as tarps and even concrete, over the aggregate. While effective in some situations, these methods are very expensive to apply and may need to be removed upon completion of a project.

One of the more cost effective stabilizing methods is the surface application of a stabilizing liquid composition. A common example of such a stabilization method is hydraulic seeding (alternatively referred to simply as “hydroseeding”). Hydraulic seeding refers to the hydraulic application of blends of water, fertilizer, and seed to a soil surface to accelerate re-vegetation. Germination of seed generally occurs in a fairly short period of time, 1 to 3 weeks, if water is available and the temperature is conducive. After germination and initial establishment of plants the surface is relatively protected from erosion by wind and water.

To stabilize the soil during the period after application but before germination occurs, a stabilizing composition may also be used and hydraulically applied either separately or with the seed and fertilizer mixture. One example of a stabilizing agent is U.S. Pat. No. 5,459,181, by West, et al. (“West”). West outlines a system using of a polymer such as guar gum (a water soluble, hydroxyl group bearing polymer), Dimethyl-ol-urea (an amine/formaldehyde condensate used as a crosslinking agent) and pH modifying salts. The disadvantages of the West system are its relatively high cost, and its use of toxic materials.

Other examples of stabilizing compositions typically used include polymers combined with borate-based crosslinking agents and antimony-based crosslinking agents using potassium pyro-antimonate. Borate-based systems form bonds between polymer molecules, but tend to be water-soluble and dissolve when exposed to precipitation. Antimony-based systems may be environmentally dangerous and may have long-term liability problems for those manufacturing and those applying the composition. Antimony is persistent in environment and tends to build up in organisms both fauna and flora. When using the antimony stabilized polymer, the resulting concentration of antimony in the soil due to the application exceeds the natural background of 5 ppb.

Another recognized drawback of the current unstabilized and not crosslinked systems approaches to soil stabilization is their longevity. The current approaches typically provide stabilization for only a few weeks or a month at most, after which the applied seed and fertilizer are lost to erosion if they have not germinated. Therefore, the current approaches are not suitable (without multiple applications which increase the cost) in areas where there is a long germination period. Some uses—such as on steep slopes, in cold environments (such as high altitude or high latitude environments), during the winter season, in very dry areas, or in areas subject to high winds—require long-term surface stabilization in which stabilizing agents may be required to remain in place for more than 6 months or through a winter season. Longevity may be increased by using high quantities of fiber (up to 3000 pounds per acre). However, this is more expensive and inhibits germination and thins the resulting coverage of vegetation.

In other applications, such as the stabilization of coal piles, tailings impoundments and stabilization of construction sites, stabilization may be required year round. In these applications, it is desirable for the stabilization from a single treatment to last as long as possible before retreatment is necessary.

One limiting factor in the development of a liquid stabilization composition that can be hydraulically applied is the viscosity of the composition. Hydraulic application of polymer, mulch, seed, and other additives depends upon control of viscosity. Viscosity affects the ability of the equipment to mix, discharge, and uniformly apply the mixture to the ground area being covered. Typical hydraulic seeding equipment is limited in its ability to handle high viscosity mixtures. An upper limit of viscosity exists at which typical equipment can no longer mix and, more significantly, pump the mixture. In addition, as viscosity increases the performance of application equipment degrades. As viscosity increases pumping becomes less efficient resulting in reduced flow rate and reduced discharge pressure. The increased viscosity limits the length of hose that can be used. The potential area of application is reduced and the equipment must be moved more often. An increased viscosity also increases droplet size of the liquid discharged from the application nozzle. As droplet size increases, liquid application becomes less uniform and more difficult. A thin, complete and continuous coverage is more difficult. A high composition viscosity also reduces the ability of the mixture to penetrate the aggregate target surface and reduces the joining of adjacent droplets into a single uniform sheet.

Accordingly there is a need for a stabilization method and composition that provides the long-term stabilization of aggregate surfaces such as a soil surface, that is effective, and that minimizes the use of hazardous chemicals. Preferably, the system would work in hydroseeding applications and in non-vegetation applications. In addition, the system should ultimately degrade in the environment so that it does not need to be removed. The present invention provides a solution to this and other problems, and offers other advantages over the prior art.

### SUMMARY OF THE INVENTION

Against this backdrop the present invention has been developed. Embodiments of the present invention are stabilizing chemical compositions and methods of applying them to surfaces, such as to soil surfaces, for protection and stabilization. The chemical compositions include one or more polymers and one or more crosslinking agents that are particularly suited to long-term soil stabilization uses. The compositions, when in an aqueous solution and applied to soil, penetrate the soil surface and react to form a crosslinked polymer film. The compositions may bind to the aggregate or simply form a film that entraps it. In embodiments, suitable polymers are water-soluble and bear hydroxyl groups (—OH) or have been modified to substitute carboxymethyl (—H₂COOH), methyl (—H₃), hydroxypropyl (—H₂CH₂CH₂OH), hydroxyethyl (—H₂CH₂OH), or ethyl (—CH₂CH₃) groups for some or all of the hydroxyl groups. Crosslinking agents include: Glyoxal; an aqueous solution of a cationic amine polymer-epichlorohydrin adduct (such as Hercules Polycup 172LX); and aqueous titanium chelate (such as DuPont Tyzor LA and Tyzor 131); a sodium zirconium lactate (such as DuPont Tyzor 217).

In addition, some embodiments include modifying agents that adjust one or more of the pH, viscosity or reactivity of the polymers and crosslinking agents. Additional embodiments include the use of fiber products, such as wood fibers, in the stabilizing composition to provide better stabilization.

Another embodiment of the present invention is a method for stabilizing a surface in which at least one crosslinking agent is mixed into 1000 parts by weight water. After mixing the crosslinking agent into the water, at least 5 parts by weight of a hydroxyl group bearing polymer is mixed into the water to create an aqueous mixture of crosslinking agent and polymer having a viscosity less than about 500 centipoise. The aqueous mixture is applied to the surface and allowed to penetrate, if an aggregate surface, and dry. Upon drying, the aqueous mixture forms a substantially water insoluble, crosslinked polymer material that stabilizes the surface. If the surface is an aggregate surface, the crosslinked polymer material may enclose some aggregate within the polymer matrix.

Another embodiment of the present invention is an aqueous mixture of 1000 parts by weight water, and at least about 5 parts by weight of a water soluble, hydroxyl group bearing polymer. The aqueous mixture has a viscosity less than about 500 centipoise and, when allowed to dry, forms a substantially water insoluble crosslinked polymer.

Another embodiment of the present invention is an aqueous mixture for hydraulic application to an aggregate surface that, when allowed to dry, forms a substantially water insoluble, crosslinked polymer on the aggregate surface. The aqueous mixture includes 1000 parts by weight water, at least about 5 parts by weight water soluble hydroxyl group bearing polymer, and at least one crosslinking agent, and has a viscosity less than about 500 centipoise.

Another embodiment of the present invention is a hydroxyl group bearing polymer crosslinking mixture including glyoxal and a heavy metal based crosslinking agent in which a weight ratio of glyoxal to the heavy metal based crosslinking agent is about 0.1 to about 1.5.

These and various other features as well as advantages which characterize the present invention will be apparent from a reading of the following detailed description.

### BRIEF DESCRIPTION OF THE DRAWINGS

FIG. 1 is a logical block diagram showing the operations of an embodiment of a method in accordance with the present invention.

FIG. 2 is a table of data for examples describing some embodiments of the present invention.

### DETAILED DESCRIPTION

Embodiments of the present invention include chemical compositions having polymers and crosslinking agents that are particularly suited to aggregate, including soil, stabilization and methods of making and using such compositions. The present invention is an improvement over existing methods as it provides effective and environmentally-friendly stabilization for longer periods at reduced cost.

The compositions, when in an aqueous mixture and applied to soil, polymerize to form a crosslinked polymer film. Aggregate particles may bind to the polymer or may be entrapped by the polymer film matrix. In the environment, the crosslinked polymer film is substantially insoluble and resistant, in the near term, to bio-degradation and natural, physical degradation due to weathering and exposure. The aqueous mixture is allowed to polymerize and dry aided by the natural elements of sun and wind. The resultant matrix of polymer film (polymer, crosslinker and modifier, if any) and aggregate or polymer film, aggregate and fiber resists erosion by strong wind and heavy rain but readily allows seeds to germinate and grow. The crosslinked film, while substantially insoluble, nevertheless is biodegradable over the long term, ultimately decaying into harmless products, principally carbon dioxide and water.

Polymer Compositions

Embodiments of the present invention are aqueous mixtures of water soluble polymer and crosslinking agent that are suitable for hydraulic application (i.e., having a viscosity of about 500 centipoise or less), have a relatively high concentration of polymer (i.e., a polymer concentration of at least about 0.5% by weight of water in the mixture), and when allowed to dry form a substantially water insoluble, crosslinked polymer.

Suitable compositions include at least one polymer, and preferably one which bonds to soil particles (clay, silica and silt) and wood, paper or other fiber for a long period of time. The polymer or blend of polymers are water-soluble and bear hydroxyl groups (—H) or have been modified to substitute carboxymethyl (—H₂COOH), methyl (—H₃), hydroxypropyl (—CH₂CH₂CH₂OH), hydroxyethyl (—H₂CH₂OH), or ethyl (—H₂CH₃) groups for some or all of the hydroxyl groups. The hydroxyl and other groups provide three functions: 1) Weak hydrogen bonding to the charged surfaces of clay-based particles; 2) Bonding to cellulose structure in fiber; and 3) Crosslinking to form continuous, water-resistant, substantially insoluble, and bio-resistant yet ultimately biodegradable films.

Examples of polymers used in embodiments of the present invention include: Guar gum (such as that sold by Rantec, Inc. under the trade names Super Tack, C7000, J3000, and HVX); Carboxymethyl guar gum (such as CM Guar sold by Maharashtra Traders); Carboxymethyl cassia seed powder (such as CM Cassia sold by Maharashtra Traders); Carboxymethyl cellulose (such as FinnFix300 sold by Noviant); Starch (corn, maize, potato, tapioca, and wet milled/spray dried starch such as GW8900 sold by KTM Industries); starches pre-treated with crosslinking agents such as epiclorohydrin and phosphorus oxychloride; Carboxymethyl starch (0.2 to 0.3 degree of substitution (DS), such as AquaBloc, KogumHS, RT3063 and RT3064 sold by Process Products N.W.); Hydroxypropyl guar gum; Hydroxyethyl guar gum; Carboxymethyl-Hydroxypropyl guar gum; Ethyl starch; Oxidized starch; and Hydroxyethyl cellulose. Other examples of polymers include Cassia seed powder, psyllium husk powder, xanthan gum, any cereal grain, annual or perennial dicot seed derived polysaccharide (sesbania, locust, bean gum, flax seed, and gum karaya).

In embodiments of the present invention, when in an aqueous mixture ready for application, the concentration of the polymer in solution is at least about 0.5% of the weight of the water in the aqueous mixture depending on the polymer or polymers used. For embodiments using only guar gum as the polymer, for example, the concentration is preferably at least about 0.5%, more preferably at least about 1%, yet more preferably at least about 1.5%, yet more preferably at least about 2.0% and most preferably at least about 2.5%. As will be discussed below in greater detail, the aqueous mixture is limited to a viscosity of no more than about 500 centipoise (cps) by the constraints of typical hydraulic application equipment, more preferably about 200 cps and most preferably about 100 cps.

The polymer in the aqueous mixture is stabilized by use of one or more crosslinking agents that are preferably environmentally friendly or that may gradually breakdown into innocuous substances. Various embodiments include one of more of the following as crosslinking agents: Glyoxal; An aqueous solution of a cationic amine polymer-epichlorohydrin adduct (such as Hercules Polycup 172LX); or heavy metal based crosslinking agents such as organic titanates and zirconates (for example aqueous titanium chelates sold by DuPont as Tyzor LA and Tyzor 131 and sodium zirconium lactate sold by DuPont as Tyzor 217). In embodiments, preferably at least some heavy metal based crosslinking agent is used.

In embodiments of the present invention, when in an aqueous mixture ready for application the concentration of the crosslinking agents in solution may range from about 15% to about 125% of the weight of the polymer in the solution depending on the agent or agents. For embodiments using only Tyzor LA (aqueous titanium chelate) as a crosslinking agent, for example, the concentration is preferably about 0.5% to about 500.0% of the weight of polymer, more preferably about 10% to about 150% and most preferably about 15% to about 25%. For embodiments using a 33% Glyoxal/67% Tyzor 217 mixture of crosslinking agents, the mixture concentration is preferably about 1% to about 125% of the weight of the polymer and more preferably about 20% to about 60% and most preferably about 30% to about 50%.

Embodiments also include mixtures of crosslinking agents that were found to be particularly effective. Embodiments include using a mixture of a heavy metal based crosslinking agent and glyoxal. Preferably, embodiments of a multiple crosslinking agent mixture in accordance with the present invention includes a glyoxal to heavy metal crosslinking agent ratio from about 0.10 to about 1.5, more preferably from about 0.25 to about 1, and most preferably from about 0.4 to about 0.6.

Embodiments of the present invention may also include modifying agents. These agents may be provided to adjust the pH in order to achieve a more favorable reaction between the polymer or polymers and the crosslinking agent or agents when in an aqueous mixture. In embodiments of the present invention, an organic acid is used to modify the pH to below about 4.5. Examples of pH modifying agents include, lime, sodium carbonate, sodium bicarbonate, sodium acetate, adipic acid, and other organic acids. Although glyoxal may be considered a modifying agent rather than a crosslinking agent, because of its effect on crosslinking it is discussed herein as a crosslinking agent rather than a modifying agent. Modifying agents may also be provided to adjust the rate of reaction between the polymer or polymers and the crosslinking agent or agents, when in an aqueous solution. Such rate adjusting modifying agents include quaternary amines, sodium metaborate, and sodium tetraborate. In addition, modifying agents may be provided to adjust the viscosity of an aqueous solution containing the polymer or polymers and the crosslinking agent or agents. Viscosity adjusting modifying agents include glyoxal and quaternary amines. Modifying agents may or may not be bound by the polymer film resulting from the reaction between the polymer or polymers and the crosslinking agent or agents.

In embodiments of the present invention, when in an aqueous form ready for application the concentration of the modifying agent or agents in solution may range from about 0% to about 5% of the weight of the water in the aqueous mixture depending on the agent or agents. For embodiments using sodium sulfate as a modifying agent, for example, the concentration is preferably about 0.005% to about 1%, more preferably about 0.01% to about 0.3% and most preferably about 0.01% to about 0.1%.

Some embodiments may include a fiber constituent to provide additional stabilization. These may be used in hydroseeding applications in combination with fertilizer and seed constituents. One example of a preferred fiber additive is aspen fiber (such as one produced by Mat, Inc., under the trademark Mat Fiber). When used in conjunction with a fiber, the preferred amount of fiber is preferably about 3% to about 20% by weight of the aqueous polymer/crosslinking agent/water mixture and more preferably about 5% to about 7% by weight (although an acceptable range is trace amounts to about 30% by weight). Since the fiber is typically in a dry form, it may be blended and packaged with other dry components (such as dry polymer or crosslinking agent components) for shipment as a combined dry mixture. Other fibers known to be useful include alderwood or other hardwood fiber, fiberized mixed wastepaper or staple synthetic fiber, which can substitute in whole or in part for the preferred aspen fiber. Any lignocellulosic fiber or synthetic fiber of a size that can be properly handled in known application equipment, such as hydroseeding machines, may be substituted in whole or in part for the aforementioned fiber material, for example, recycled paper, hay, straw, fiberized wood construction waste, fiberized rag stock, bagasse, coconut fibers and the like. The fluid may also be applied over the dry fiber (the fiber, such as straw tacking is used as mulching) to stabilize the fiber and prevent its loss due to wind or water.

In embodiments of the present invention, some or all of the constituent components may be in a pre-mixed blend in a dry form that is water soluble. Prior to mixing with water the pre-mixed blend is substantially stable and does not significantly react. Alternatively, some embodiments of the present invention include compositions wherein two or more of the constituents are mixed at the time of using. In these embodiments, the constituents may be added to water in a dry form or a concentrated liquid form or some combination of the two. Some embodiments of the present invention may require the constituents to be mixed in a certain order or at a certain temperature.

Embodiments of the present invention may be a combination of a pre-mixed dry component and a pre-mixed liquid component. For example, in some embodiments, the polymer and certain modifying agents (sodium metaborate, lime, and/or a fiber constituent, for example) may be provided in a dry form, while the crosslinking component and possibly other components of the composition are provided in a liquid form. The aqueous mixture is formed when the two components are mixed together in water prior to application.

In some embodiments, upon mixing with water one or more of the constituents may begin to react. This reaction may or may not be the reaction that ultimately produces the soil stabilizing film. In other embodiments, a trigger for the reaction that ultimately produces the polymerization reaction may be required. Such a trigger may be provided by a modifying agent, exposure of the aqueous solution to the air, or by means of the application process.

The composition may be applied to the soil or aggregate while in an aqueous solution. In some embodiments, the aqueous solution containing the composition is applied to the soil surface via a spraying apparatus, such as the spraying apparatuses used in typical hydroseeding applications. In these embodiments, the operator may mix the composition with water in a mixing tank and then spray the soil surface of the area to be stabilized while the polymerization reaction is ongoing but before it has completed. In embodiments in which the composition is provided as separate components, e.g., a pre-mixed dry component and a pre-mixed liquid component, the components may be combined when mixed with the water. Depending on the application, other components may be mixed into the water also. For example, in hydroseeding applications, seed and fertilizer can be added to the mix (at the normal rates used in conventional hydroseeding). In applications using a fiber additive, the fiber may be added to the mix. Application rates of the aqueous solution on soil to provide adequate stabilization range from about 50 to 500 pounds of polymer per acre, preferably range from about 100 to about 300 pounds of polymer per acre and most preferably range from about 150 to about 250 pounds per acre.

The applied aqueous solution is allowed to permeate the soil or aggregate surface and dry aided by the natural elements of sun and wind. Upon drying, a crosslinked polymer film develops that may bind to some of the soil or aggregate particles and may entrap particles in the film. The resultant film resists erosion by strong wind and heavy rain. In hydroseeding embodiments wherein seed is included in the composition, the film readily allows the seed to germinate and grow up within and through the film. As previously explained, the resulting crosslinked film is now substantially insoluble but nevertheless is ultimately biodegradable, decaying into harmless products, principally carbon dioxide and water and harmless trace amounts of other compounds such as zirconium oxide. Until such time, the film provides substantial stabilization of the soil or aggregate surface over a long-term period.

Embodiments of the application method also contemplate other application methods such as aerial application via either fixed wing or rotary aircraft, through dump gates or nozzle applicators, with irrigation-related equipment such as side-roll sprinklers, impulse gun sprinklers or center pivot sprinklers, and spraying systems on mobile equipment.

Other uses for the present invention include long-term stabilization of garbage piles, coal piles, mining spoils piles to prevent acid mine drainage, tailings impoundments to prevent airborne dust pollution, and the like. Additionally, application of the present invention on gravel and dirt roads as a form of dust suppression is possible.

Viscosity Reduction Techniques

The hydraulic application of the composition is enhanced when the viscosity of the liquid to be applied is kept preferably below about 500 centipoise (cps), more preferably below about 200 cps, and most preferably below about 100 cps. Viscosity affects the ability of the equipment to mix, deliver, and uniformly apply the mixture to the ground area being covered. It has been determined that liquids with viscosities below about 500 cps are hydraulically applicable by experienced and skilled hydroseeding operators with standard equipment in good repair. However, it has also been determined that to provide for a margin of safety to account for field conditions (such as less experienced operators, poor equipment, etc.) a viscosity of below about 200 cps is more preferable and a viscosity of below about 100 cps is most preferable. Viscosity can be reduced, of course, by reducing the concentration of polymer in the aqueous mixture. But this is undesirable, as it requires a proportional increase in the use of water for a given amount of polymer and thus a given treatment area. By increasing the amount of polymer in the aqueous mixture while remaining under the viscosity limits of the hydraulic application equipment, significant amounts of water may be saved, requiring less water to be used in treating a given area. As the cost of water, in general, is one of the largest costs in the application process (primarily because of the labor and transportation costs required to obtain, mix, pump, and handle each load of water), the ability to increase the concentration of polymer while remaining within acceptable viscosity range is very important. Water efficiency is even more important if aerial application is required, the water cost is even greater due to the limited carrying capacity and relatively higher cost of aviation fuel.

Another embodiment of the present invention is the use of depolymerized polymer to reduce the viscosity of the aqueous mixture at a given polymer concentration. Depolymerization refers to the act of reducing the average molecular weight of a polymer. Many methods of depolymerizing polymers are known in the art including enzymatic, chemical, and physical methods such as irradiation. While some provide more control of molecular weight reduction than others, any are applicable here because a close control of molecular weight is not necessary in this application as the goal is an overall reduction in viscosity. The preferred type of depolymerization is irradiation—particularly gamma irradiation or electron beam irradiation, although other types of depolymerization can also be used. Controlling the dose of the depolymerizing agent (i.e., peroxide, enzyme, or radiation dose) affects the amount of depolymerization and, subsequently, controls the reduction the viscosity of the aqueous composition. It has been determined that increasing degrees of depolymerization allow for increasing polymer concentrations in an aqueous mixture at a given viscosity without significantly affecting the properties of the crosslinked polymer matrix obtained after drying of the aqueous mixture. Increasing polymer concentrations to concentrations in the range of at least about 40 to at least about 160 lb per 1000 gallons (about 0.5% to about 2% polymer by weight) can reduce water use by factors of 2 to 4. Examples 1 and 2 illustrate the difference between using non-depolymerized and depolymerized polymer on the viscosity of the aqueous mixture.

In some embodiments of the present invention, polymers were depolymerized using electron beam irradiation. The type and dosage of the irradiation that can be employed in the practice of this invention will vary depending on the type of polymer treated, the degree of molecular weight reduction desired, and the form of the polymer, i.e. whether the polymer is in the form of a salt. The dosage of irradiation used varies from about 1 kiloGray (kGy) to about 120 kGy. In some embodiments, polymers were subjected to electron beam radiation in doses more preferably ranging from about 2 kGy to about 75 kGy and most preferably ranging from about 5 kGy to about 50 kGy.

In alternative embodiments, commercially available depolymerized polymer, such as the chemically depolymerized guar gum sold by Hindustan Gum and Chemical under the name TDP-20 and GuarDepoly Jaguar 8800 a guar gum chemically depolymerized (by caustic and peroxide) sold by Rhodia Group, was used.

Yet another embodiment of the present invention is a method of mixing the polymer and crosslinking agent that reduces the viscosity of the resulting aqueous composition. The addition of crosslinking agent to raw water prior to addition of any other ingredients, particularly the polymer, significantly reduces the viscosity of the fluid over that of adding the crosslinking agent after the polymer. It is believed that this is probably due to the immediate crosslinking of polymer molecules to themselves delaying the hydration and association of the polymer with the water. In any event, the use of this method reduces the viscosity of the aqueous composition significantly and makes higher concentration of polymer practical. Examples 3 and 4 illustrate the effect of the mixing order of the polymer and crosslinking agent on the viscosity of the resulting mixture.

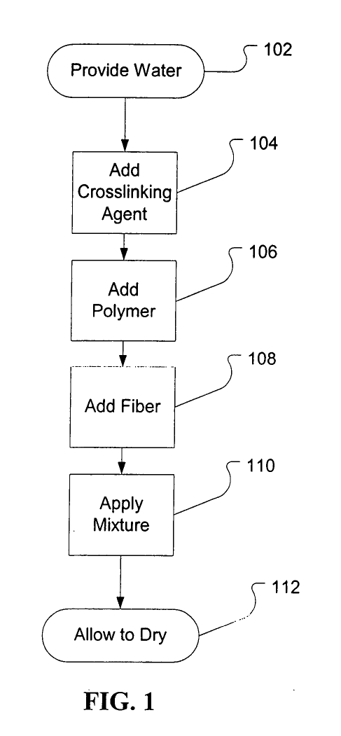

FIG. 1 is a block diagram illustrating a method for stabilizing a soil surface or other aggregate surface in accordance with an embodiment of the present invention. The method mixes the polymer and crosslinking agent in a way that reduces the viscosity of the resulting aqueous mixture of polymer and crosslinking agent. The method of FIG. 1 starts with obtaining water in a providing water operation 102. Preferably, the water is obtained and provided in a mixing vessel from which the final aqueous mixture may be directly dispensed onto the soil surface. Examples of such a vessel include lagoons or other surface impoundments as well as fixed or mobile storage tanks. For small applications, a combination water tank and spraying apparatus such as garden sprayer may be used. For large application a tank and sprayer equipped vehicle, such as a water dispersing truck suitable for hydroseeding operations or tank and sprayer equipped aircraft may be used. Alternatively, the mixing may occur in a different vessel from the dispersing vessel, and the resulting aqueous mixture subsequently transferred to the dispersing vessel after mixing.

A crosslinking agent mixing operation 104 next adds and mixes a crosslinking agent or agents into the water in the tank. The mixing can be achieved by active mixing through the use of mixing elements in the vessel. Alternatively, passive mixing may be used, such as mixing due to agitation during transport may be used.

After the crosslinking agent or agents are mixed into the water, a polymer mixing operation 106 is performed in which the polymer is added and actively mixed into the water. This may require the addition of a liquid or a dry composition that contains the polymer. Polymer mixing operation 106 adds and mixes into the water at least about 0.5% by weight of a water soluble, hydroxyl group bearing polymer to create an aqueous mixture of crosslinking agent and polymer having a viscosity less than about 500 cps. Preferably, while maintaining the viscosity below about 500 cps, at least about 0.5% by weight is added and mixed into the water, more preferably the amount is at least about 1%, yet more preferably the amount is at least about 1.5%, yet more preferably the amount is at least about 2%, and most preferably the amount of polymer is at least about 2.5%. Alternatively, while maintaining the viscosity below about 200 cps, at least about 0.5% by weight of polymer is added and mixed into the water, more preferably the amount is at least about 1%, yet more preferably the amount is at least about 1.5%, most preferably the amount is at least about 2%. The polymer used may be any polymer described above (i.e., guar gum, carboxymethyl guar gum, carboxymethyl cassia seed powder, carboxymethyl cellulose, starch, starches pre-treated with crosslinking agents such as epiclorohydrin and phosphorus oxychloride, carboxymethyl starch, hydroxypropyl guar gum, hydroxyethyl guar gum, carboxymethyl-hydroxypropyl guar gum, ethyl starch, oxidized starch, hydroxyethyl cellulose, cassia seed powder, psyllium husk powder, xanthan gum, any cereal grain, or annual or perennial dicot seed derived polysaccharide). The polymer or polymers used may be previously depolymerized to reduce their average molecular weight as described above, thus further reducing the viscosity of the aqueous mixture.

Next, an optional fiber addition operation 108 may be performed in which fiber is mixed into the aqueous mixture. In the fiber addition operation, fiber in an amount of about 3 to about 20% of the weight of the aqueous mixture may be added. As described above, more preferably between about 5% to about 7% by weight fiber is added. Alternatively, the fiber manufacturer's recommendations for the amount of fiber to be added may be used. For hydroseeding applications, a seed, fertilizer, or a combination of the two, may also be added in a hydroseed constituent addition operation (not shown).

After addition and mixing of the polymer and fiber, the aqueous mixture is applied to the surface that is to be treated in an application operation 110. This may involve pumping and spraying the aqueous mixture from the mixing or a holding vessel.

After application, the aqueous mixture is allowed to dry in a drying operation 112. The drying may occur naturally due to natural evaporation and saturation of the underlying soil. Upon drying, the polymer and crosslinking agents create a substantially water insoluble, biodegradable, crosslinked polymer matrix on the surface of the soil. If fiber was added in the fiber addition operation, the fiber may be encapsulated in or bonded to the matrix.

At any time prior to the addition of the polymer to the water and subsequent mixing of the polymer into the water, modifying agents such as those described above may be added to the water. The modifying agents may be added as part of the crosslinking agent mixing operation 104 or, alternatively, added in a separate operation (not shown). For example, in one embodiment a modifying agent in the form of an organic acid, such as adipic acid, acetic acid, formic acid, etc., is added to reduce the pH of the aqueous mixture to less than about 4.5. In an alternative embodiment, some modifying agent may be added to the water during or after the addition of the polymer in the polymer mixing operation 106.

Alternative Uses

The embodiments described above were described in the context of the stabilization of soil and other aggregates via the application of the aqueous mixture to a soil/aggregate surface. Embodiments of the present invention are also suitable for other applications.

Some embodiments of the present invention may be applied to foliage to create a polymer film/coating on the exterior of the foliage. If an additional chemical agent is included in the aqueous mixture, the embodiments are a useful means for providing long term, but biodegradable, means of covering the foliage with the chemical agent. Chemical agents such as deer repellant (a compound particularly offensive to deer that when coated onto foliage, prevents deer from eating the foliage), insecticide, and ultraviolet blocking sunscreen may be mixed into an aqueous polymer/crosslinking agent mixture and sprayed on the foliage. When the mixture dries, a crosslinked polymer coating is formed on the surface of the foliage that contains the chemical agent. Because the crosslinked polymer is substantially insoluble, the coating will not be removed by natural precipitation. However, because the crosslinked polymer is also biodegradable, the coating will not be permanent. In addition, the resulting crosslinked polymer is semi-permeable and will not adversely affect the foliage.

Yet other embodiments are suitable for firefighting applications, particularly to applying fire retardant to foliage and structures that are threatened by wildfire. In the embodiments, the fire retarding chemicals are mixed into the aqueous mixture and applied either by aircraft (aerial application) or ground vehicles on to the foliage or structures to be protected.

Yet other embodiments are related to environmentally friendly, impermanent but long term markings. In the embodiments, inks, dyes or paints may be mixed into the aqueous mixture to provide color to the crosslinked polymer after drying of the mixture. This allows easy, cost effective, and relatively long term marking of trails, trees, rocks or other natural features.

Yet other embodiments are suitable for daily covering of landfills to provide temporary stabilization. Embodiments of the present invention could be applied for night protection or for temporary protection during the covering operation.

### EXAMPLES

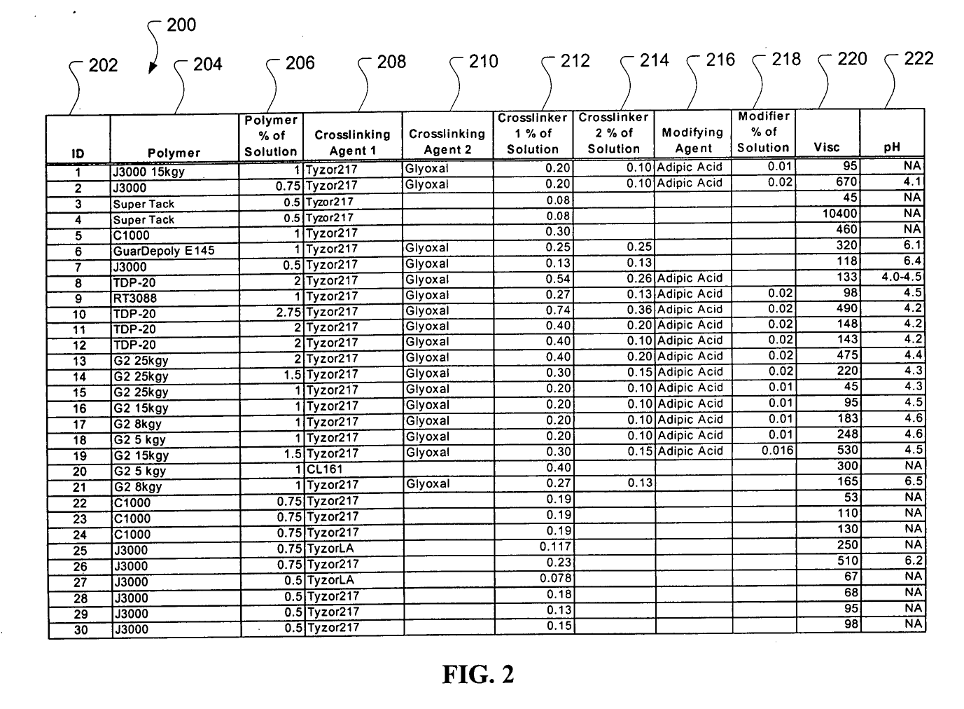

FIG. 2 is a table of data and includes the results of examples of embodiments of the present invention. The examples are given by way of illustration and are not intended to limit the invention. The examples are numbered and discussed in detail below.

The methodology used in the examples was, unless otherwise specified in the discussion of specific examples, to obtain a sample of 500 milliliters (ml) of water. Next, unless otherwise specified, the crosslinking agent or agents were added to the sample and mixed for 1 to 5 seconds. After the mixing, the polymer was added and the aqueous mixture was mixed for another 2 minutes. The mixture was then allowed to sit for 15 minutes after which the viscosity and pH were measured. If a modifying agent were used, it would be added at the same time as the crosslinking agent. Next, a proportional quantity on a weight per unit area basis of the aqueous mixture was then poured into a dish to air dry. The resulting film on drying was approximately 0.2 to 0.5 mm thick. In some cases fiber such as Mat Fiber was added in the correct proportion in the remaining solution. The resulting mixture of crosslinker, polymer and fiber (if any) was then poured into a shallow pan to dry. The resulting dry matrix was 2 to 5 mm thick.

Examples 1, 3, and 5-30 listed in FIG. 2 represent crosslinked polymers deemed substantially insoluble and suitable for use in the environment as a soil stabilization polymer. Insolubility of the dried crosslinked polymer was determined using the following tests. In a first test referred to as the “coupon mixing” test, the longevity of polymer/fiber coupons under water soak and agitation was examined. Coupons 1″×2″ were cut from the dried matrix for testing. The coupon was placed in 500 ml of water in a 600 ml beaker and mixed at 300 revolutions per minute (rpm) on a magnetic stirrer with a 1.5 inch stir bar. The amount of time until the coupon dissolved was measured. If the coupon survived and remained intact after 24 hours of mixing without tearing, dissolving, or falling apart, the polymer was deemed substantially insoluble. The results of coupon mixing tests on multiple samples indicated that, in general, the crosslinked polymer coupons either dissolved or broke apart very quickly (less than 2 hours) or did not show any significant change within the 24 hour period.

Using that knowledge, a more efficient solubility test was developed. In the second test, distilled water was added to completely cover the dried film in the dish. The film was immediately rubbed with the finger to determine if any immediate solubility was shown. Solubility was indicated by lubricity of the film surface-the lubrication evidence of the dissolution of the polymer. After allowing the water to stand on the film for a period of 3 to 5 minutes the film was again examined by rubbing with the finger. Film strength and solubility were judged by the ability of the film to resist rubbing. Soluble films tend to dissolve under this action. The test was continued with periodic examinations until the film failed or 24 hours had passed. Failure was judged to be dissolution into the water, tearing of the film, or breaking up of the film into tiny particles. A good correlation between the coupon mixing test and the second test was observed. Soluble films typically failed quickly, i.e., within 30 seconds to five minutes of the start of the test. Films deemed substantially insoluble did not fail until after about 8 hours with most films in the examples showing no evidence of failure or lubricity during the 24 hours test period. Polymers that survived the second test without damage for at least 8 hours were, therefore, also considered substantially insoluble and suitable for use in a natural environment. In some cases, the polymer was observed to swell when soaked in water, however, this was not indicative of ultimate solubility or strength.

In reading the data in FIG. 2, the following information is needed. The first column 202, titled “ID”, in table 200 contains the ID number of the example. The second column 204, titled “Polymer”, contains the name of the polymer used. Table 1, below, lists the polymers in the examples, the corresponding polymer type and the polymer manufacturer if the polymer is commercially available.

TABLE 1

| Polymer Name | Polymer Type | Commercial Manufacturer |
|---|---|---|
| CMStarch Kogum HS | Carboxymethyl starch | Process Products N.W. |
| GW8900 | Starch | KTM Industries |
| J3000 | Guar gum | Rantec, Inc. |
| Super Tack | Guar gum | Rantec, Inc. |
| C1000 | Guar gum | Rantec, Inc. |
| GuarDepoly Jaguar 8800 | Chemically depolymerized | Rhodia Group |
| | guar gum | |
| TDP-20 | Chemically depolymerized | Hindustan Gum and Chemical |
| | guar gum | |
| RT3088 | Low Viscosity Guar gum | Habgen Gum Limited |
| G2 #kGy | Depolymerized Guar gum | NA |
| | depolymerized by an electron | |
| | beam irradiation dose of #kGy | |

The third column 206, titled “Polymer % of Solution”, contains the amount of Polymer used as a percent of the weight of water used for the sample. For example, if a 500 ml water sample were used, 1% would correspond to 5 grams of polymer.

The fourth column 208, titled “Crosslinking Agent 1”, contains the name of the first crosslinking agent used. The fifth column 210, titled “Crosslinking Agent 2”, contains the name of the second crosslinking agent (if any) used. The crosslinking agents are as follows:

TABLE 2

| Crosslinking Agent Name | Agent Type | Manufacturer |
|---|---|---|
| TyzorLA | Titanium chelate | DuPont |
| STMP | Sodium tri-meta phosphate | Various |
| Polycup172LX | Cationic amine polymer- | Hercules |
| | epichlorohydrin adduct | |
| Glyoxal | 1,2-Ethanedione Biformyl | BASF |
| | Ethandial | |
| Tyzor217 | Sodium zirconium lactate | DuPont |
| CL161 | Borate containing | CESI Chemical |
| | compound | |

The sixth column 212, titled “Crosslinker 1% of Solution”, contains the amount of Crosslinking Agent 1 used as a percent of the weight of water used for the sample. For example, if 500 ml of water were used as the sample, then 0.1% would correspond to 0.5 grams of crosslinking agent. The seventh column 214, titled “Crosslinking Crosslinker 2% of Solution”, contains the amount of Crosslinking Agent 2 used, if any, as a percent of the weight of water used for the sample. The eighth column 216, titled “Modifying Agent”, lists the modifier agent, if any, used. The ninth column 218, titled “Modifier % of Solution”, contains the amount of modifier agent used, if any, as a percent of the weight of water used in the sample.

The tenth column 220, titled “Viscosity”, is the viscosity in centipoise (cps) of the aqueous mixture measured approximately 15 minutes after addition and mixing of listed the Polymers, Crosslinking Agents, and Modifying Agents. Viscosity is that viscosity determined with a Brookfield Model RVT at a speed setting of 20 rpm and the appropriate spindle to provide accurate readings within the manufacturers guidelines. The eleventh column 222, titled “pH”, is the pH of the aqueous mixture measured 15 minutes after addition of the polymer.

### Examples 1 & 2

Examples 1 and 2 illustrate the difference in viscosity obtained between the use of depolymerized polymer and non-depolymerized polymer. In example 1, a depolymerized guar gum product, J3000, was used. The polymer was depolymerized by a dose of 15 kGy of radiation as described above. In the resulting aqueous solution using the depolymerized J3000, a viscosity of 95 cps was obtained. Example 2 shows a similar experiment in which non-depolymerized J3000 was used and a viscosity of 670 cps was obtained. The only difference between these two examples, besides the state of polymerization, is the amount of polymer used. More depolymerized polymer was used in example 1 (1.0% of the weight of solution) than example 2 (0.75% by weight of non-depolymerized J3000). These results clearly illustrate the reducing effect on viscosity of the aqueous solution of the use of depolymerized polymer. Both examples resulted in a substantially insoluble crosslinked polymer when dried. However, the viscosity of example 2 made it unsuitable for hydraulic application.

### Examples 3 & 4

Examples 3 and 4 illustrate the effect of the order of addition of the crosslinking agent to the viscosity of the aqueous mixture. The two examples are identical in every respect except for the timing of the addition of the constituents when creating the aqueous mixture. In example 3, the crosslinking agent was added prior to the addition of the polymer and a low viscosity of 45 cps for the aqueous mixture was obtained. In example 4, on the other hand, the crosslinking agent was added 5 minutes after the addition of the polymer and a high viscosity of 10400 cps was obtained. Again, both examples resulted in a substantially insoluble crosslinked polymer. However, example 4 was not suited to hydraulic application as its viscosity was so high.

### Examples 5-36

FIG. 2 shows, in tabular form, the results of 26 examples (ID numbers 5 to 30) of embodiments of the present invention having concentrations of at least about 0.5% polymer (by weight of water) with viscosities of about 500 cps or less and that formed a substantially insoluble, crosslinked polymer upon drying. In the examples shown, embodiments of the present invention having polymer concentrations of between about 2% and about 2.75% by weight of the water in the aqueous mixture while maintaining the viscosity below about 500 cps were obtained (see Example IDs #10 and 13). Embodiments with polymer concentrations of between about 1% and about 2% and viscosities of less than about 200 cps were also obtained (see Example IDs #8, 11, 12, 14, 17, and 21). Embodiments with polymer concentrations of about 1% and viscosities of less than about 100 cps were also obtained (see Example IDs #9, 15, and 16). Embodiments with polymer concentrations of between about 0.5% and but less than about 1% and viscosities of less than about 100 cps were also obtained (see Example IDs #7, 22-24, and 27-30). Embodiments with polymer concentrations ranging from about 1% to about 2% with viscosities less than about 500 cps were obtained (see Example IDs #5, 6, 18, 19, and 20).

It will be clear that the present invention is well adapted to attain the ends and advantages mentioned as well as those inherent therein. While presently preferred embodiments have been described for purposes of this disclosure, various changes and modifications may be made which are well within the scope of the present invention. For example, a polymerization inhibitor may be added to allow the composition to more completely permeate the soil before the polymerization occurs. Numerous other changes may be made which will readily suggest themselves to those skilled in the art and which are encompassed in the spirit of the invention disclosed and as defined in the appended claims.

1-14. (canceled)

15. A method for stabilizing an aggregate surface comprising:
providing 1000 parts by weight water;
mixing into the water at least one crosslinking agent;
after mixing the crosslinking agent into the water, mixing into the water at least 5 parts by weight of a hydroxyl group bearing polymer to create an aqueous mixture of crosslinking agent and polymer having a viscosity less than about 500 centipoise;
applying the aqueous mixture to the aggregate surface; and
allowing the aqueous mixture to dry and form a substantially water insoluble, crosslinked polymer material that stabilizes the surface.

16. The method of claim 15 further comprising:
after mixing the polymer into the water, mixing into the water about 50 to 70 parts by weight of a fiber constituent.

17. The method of claim 15 wherein the mixing of polymer further comprises:
after mixing the crosslinking agent into the water, mixing into the water at least about 10 parts by weight of the hydroxyl group bearing polymer.

18. The method of claim 15 wherein the aqueous mixture has a viscosity less than about 200 centipoise.

19-22. (canceled)
